(19) United States
(12) Patent Application Publication
(10) Pub. No.: US 2014/0182419 A1
(43) Pub. Date: Jul. 3, 2014

(54) Motor Accelerator for Automatic Screwdriver

(71) Applicant: Hsiu-Lin HSU, New Taipei City (TW)

(72) Inventor: Hsiu-Lin HSU, New Taipei City (TW)

(21) Appl. No.: 13/730,699

(22) Filed: Dec. 28, 2012

(51) Int. Cl. B25B 21/00

(52) U.S. Cl. CPC B25B 21/008
USPC 81/57.11

(57) ABSTRACT

A motor accelerator for automatic screwdriver, which is mainly combined with a motor mechanism in automatic screwdriver. The accelerator comprises a bearing (or sleeve) or more interconnected bearings (or sleeves), so as to increase the mass and radius of motor (rotor) and the rotational speed and rotational inertia, thus substantially improving the performance and efficiency; as the accelerator is made of metal materials, this enables satisfactory heat dissipation for rotor; moreover, the accelerator is fitted with a spring (or magnet) to connect the motor, allowing the automatic screwdriver to realize mechanical slow start with small energy (small airflow or low current) output and auxiliary braking function when the automatic screwdriver is stopped.

### BACKGROUND OF INVENTION

1. Field of the Invention

The present invention relates generally to an improved structure of pneumatic motor, and more particularly to a motor accelerator for automatic screwdriver which could improve its speed and torque to obtain better performance without change of its original volume, and could also realize mechanical slow startup and auxiliary braking with low current.

2. Description of Related Art

Locking a screw generally includes the following four steps:
1. Set a position to lock the screw;
2. Rotate the screw to allow it to move along the rotation axis;
3. Keep rotating until that the screw head contacts with the locked object and tensile stress is generated;
4. Stop the rotation when a certain tensile stress has been completed between the screw head and locked object.

FIG. 1 depicts that the screw is locked by an automatic power screwdriver as per the locking steps; of which, the screw is at idle state at P1, the power screwdriver is accelerated from zero to P2 for full speed, then decelerated at P3, and finally stopped at P4, so the power screwdriver is provided with a reduction gear and clutch mechanism; when the power screwdriver stops, the motor is not completely stopped; but completely stopped at P5; referring to FIG. 2, this action is converted to a relational view of motor's rotational speed and time.

If assuming M stands for the mass of motor rotor, R for radius, H for length; the rotational speed is respectively represented by ω1, ω2, ω3 and ω4 correspondingly to P1, P2, P3 and P4; its rotational inertia is I=Mr /2; angular momentum is L=Iw(1, 2, 3, 4); rotational kinetic energy is T=1/2[Iω(1, 2, 3, 4)]; in mechanics 1 fixed axis in inertial space 2 passes through the rotation axis of centroid, and the moment is equal to the change rate of angular momentum, so the generated torque is τ=T(ω3−ω4)d/dt(3-4), and this torque will generate torsion to the power screwdriver. Thus, the greater slope of P3-P4 means larger torsion. Referring to rotational speed drawings of motor in FIG. 2, without change of the motor's internal design and power, maximum torsion could be obtained by reducing the area of P3-P4, increasing the rotational speed of rotor and I (rotational inertia) to increase the mass or radius of the rotor.

In addition, FIG. 3 depicts a load diagram that common screw is locked by using a fixed torsion value, wherein no load occurs at the beginning, after that some load is generated due to frictional resistance when the thread of screw contacts with the object; this process occurs in the idle running of the screw; finally, when the screw head contacts with the screwed object surface, the load is rapidly increased to the fixed torsion and then stopped owing to tension effect.

Referring also to FIG. 4, generally, an automatic tool starting from standstill to fixed no-load torsion usually takes relatively short time.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### SUMMARY OF THE INVENTION

The primary objective of the present invention is to provide a motor accelerator for automatic screwdriver, which could increase the motor's torsion output, the mass or radius of the rotor to increase the rotational speed and rotational inertia of the rotor, thus enhancing substantially the performance and efficiency.

Another objective of the present invention is to provide a motor accelerator for automatic screwdriver, which is made of metal materials enabling heat dissipation for the rotor.

The other objective of the present invention is to provide a motor accelerator for automatic screwdriver, which is fitted with a spring to make the start energy (small airflow or low current) output of the automatic screwdriver turn smaller, and also provided with slow startup and auxiliary braking functions.

To this end, the present invention is technically designed in a way that, without change of the motor's internal design and power, an accelerator is incorporated into the motor mechanism in a common automatic screwdriver; said accelerator could be operated in tune with changes of the torsion and rotational speed of the automatic screwdriver, and permit c rotational inertia adjustment for the motor mechanism (rotor) in different proportions, enlarging output horsepower and enhancing the torsion for optimized performance; the automatic screwdriver comprises: a motor mechanism, gear mechanism, torsion mechanism, chuck mechanism, trigger mechanism and electronic mechanism, etc. Particularly, the motor mechanism is combined with an accelerator which comprises of a single bearing (or sleeve) or more interconnected bearings (or sleeves); so this combination could increase the mass and radius of motor (rotor), thus improving the rotational speed and rotational inertia and also enhancing the torsion of motor.

The accelerator is made of any of metal materials like aluminum, copper, iron and steel; which enable heat dissipation during motor (rotor) operation.

The accelerator is provided with a connecting member to connect the mandrel and bearing (or sleeve) of the motor mechanism.

The accelerator can be further provided with a spring.

The accelerator can be further provided with a magnet.

The automatic screwdriver could be designed into electric or pneumatic type.

The automatic screwdriver could be designed into any of vertical, gun-shaped or elbowed pattern.

The features and advantages of the present invention will be more readily understood upon a thoughtful deliberation of the following detailed description of a preferred embodiment of the present invention with reference to the accompanying drawings:

### BRIEF DESCRIPTION OF THE DRAWINGS

FIG. 1: an actuating view of locked screw of an automatic power screwdriver.

FIG. 2: a relational view of the motor speed and time of the power screwdriver.

FIG. 3: a load view that a common screw is locked by a power screwdriver using fixed torsion value.

FIG. 4: a relational view of the torsion and time when the power screwdriver starts from standstill to fixed no-load.

FIG. 5: an exploded view of the motor accelerator for automatic screwdriver of the present invention.

FIG. 6: an assembled view of the motor accelerator for automatic screwdriver of the present invention.

FIG. 7: an assembled sectional view of the motor accelerator for automatic screwdriver of the present invention.

FIG. 8: another assembled sectional view of the motor accelerator for automatic screwdriver of the present invention.

FIG. 9: another assembled sectional view of the motor accelerator for automatic screwdriver of the present invention.

FIG. 10: a comparison view of the torsion and time when the present invention and common power screwdriver start from standstill to fixed no-load.

FIG. 11: a comparison view of the output torsion and time when the motor's stop is prolonged by the present invention and common power screwdriver in standstill state.

FIG. 12: a maximum torsion output table of the accelerator when the present invention is applied to pneumatic screwdriver and different weights are provided.

FIG. 13: a maximum torsion output table of the accelerator when the present invention is applied to electric screwdriver and different weights are provided.

FIG. 14: a relational view of motor and current when the present invention is applied to automatic screwdriver and common automatic screwdriver.

FIG. 15: a comparison view of the torque counterreaction when the present invention is applied to automatic screwdriver.

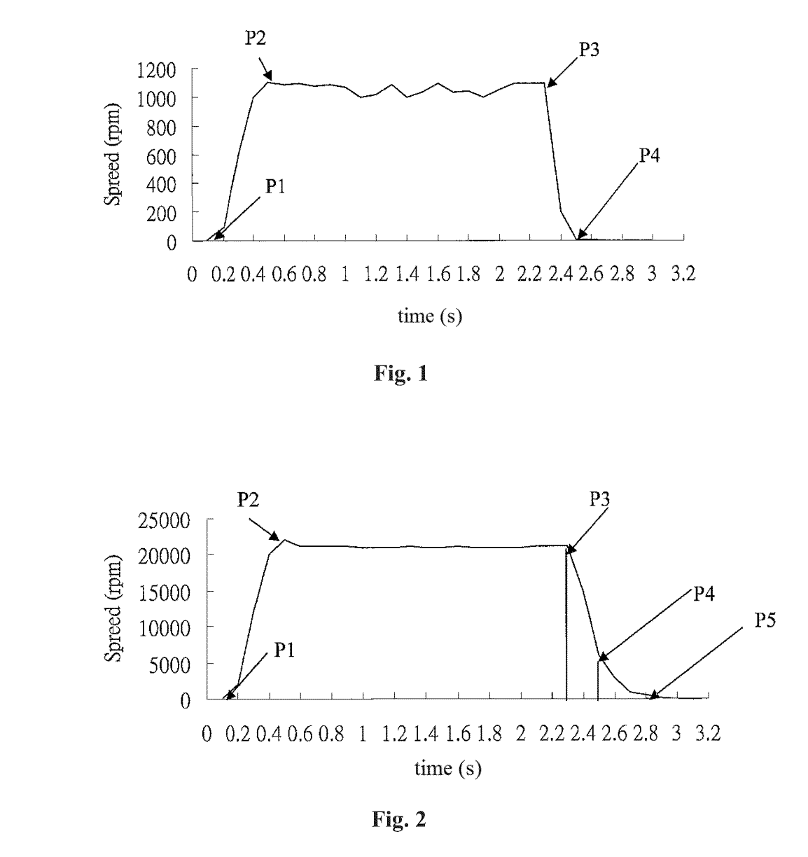

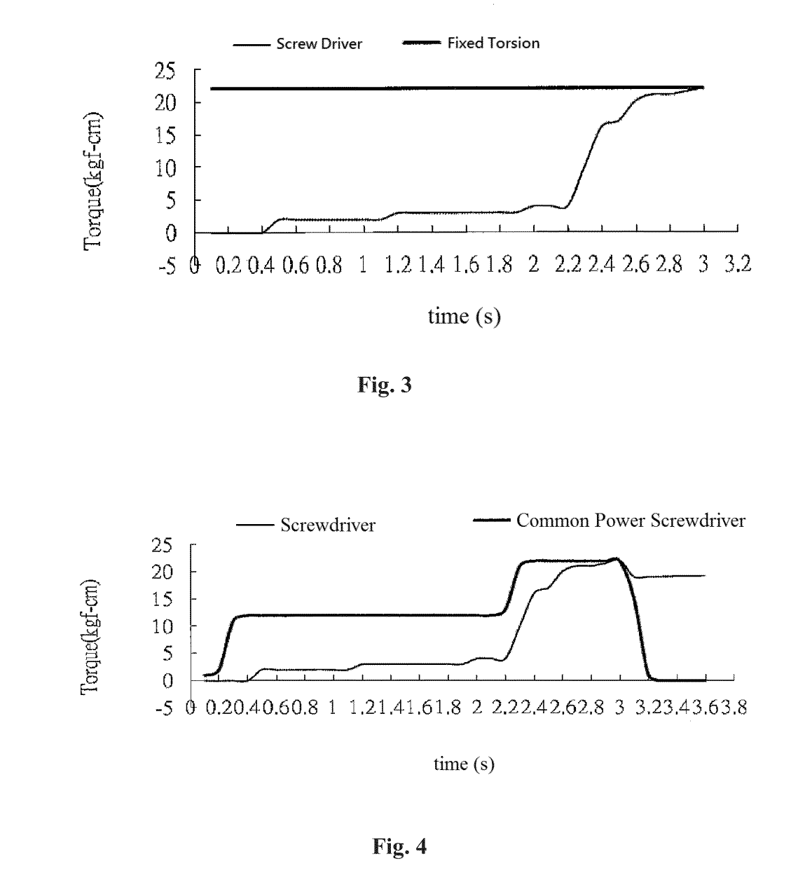

### DETAILED DESCRIPTION OF THE INVENTION

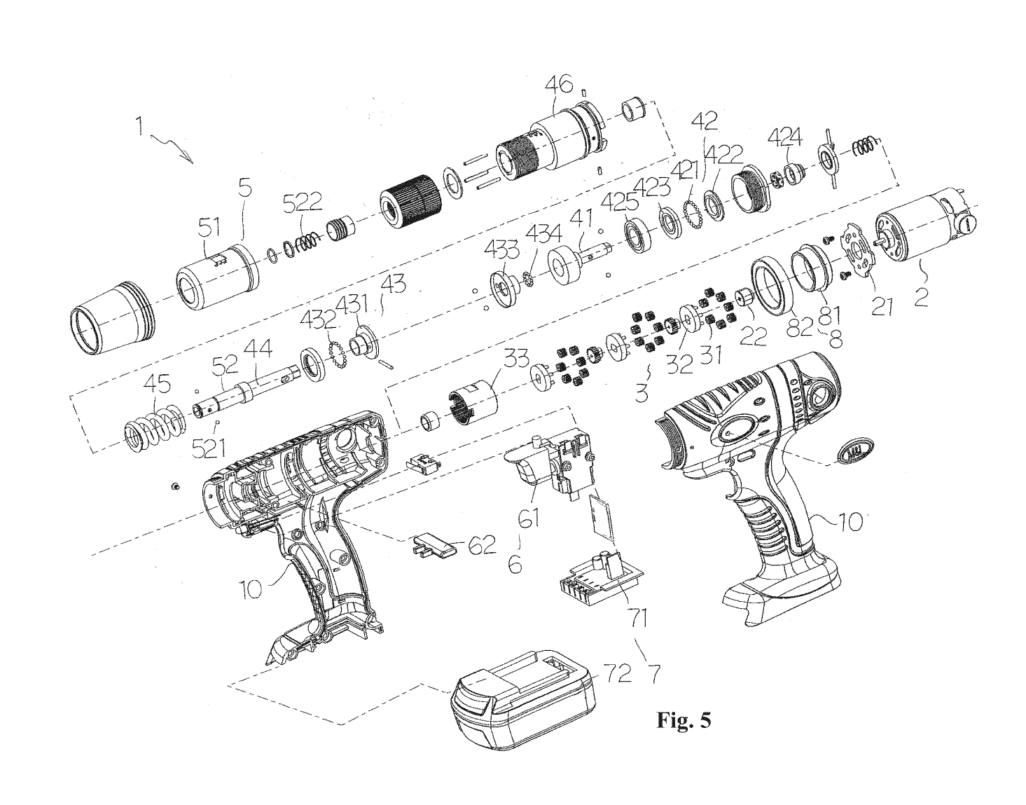

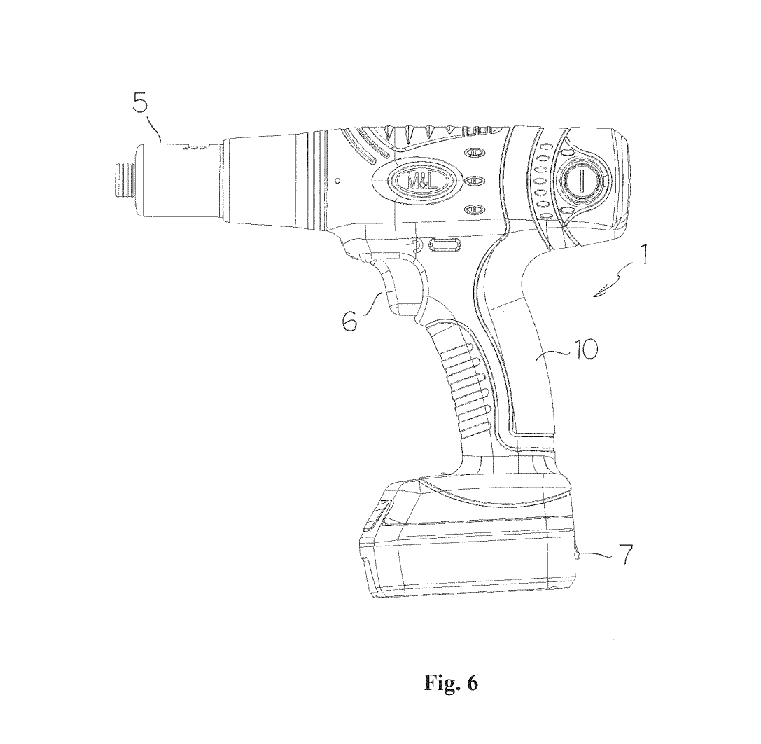

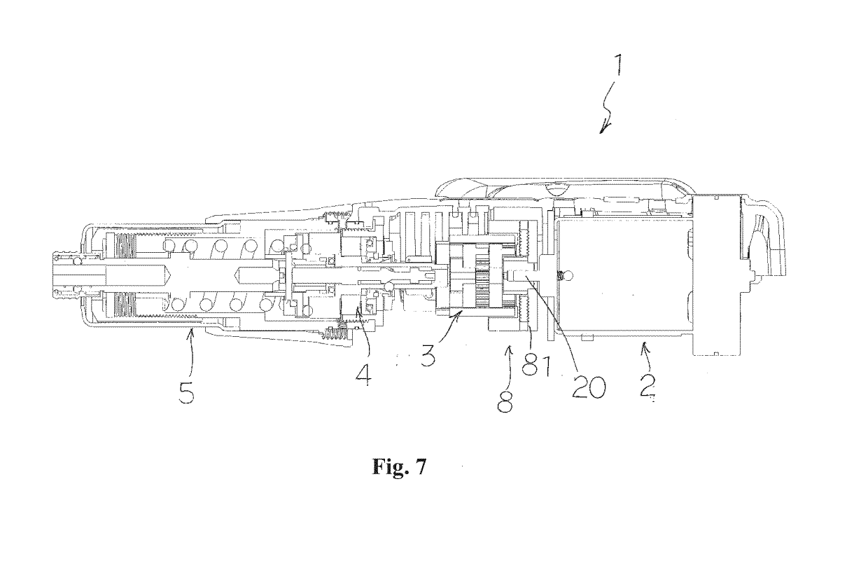

FIG. 5 depicts an exploded view of the automatic screwdriver of the motor accelerator, wherein the automatic screwdriver could adopt existing electric or pneumatic types, and could be designed into vertical, gun-shaped or elbowed patterns. In the present embodiment, the gun-shaped pneumatic screwdriver is taken as an example.

The pneumatic screwdriver 1 comprises of a group of combined housings 10, including at least: motor mechanism 2, gear mechanism 3, clutch mechanism 4, chuck mechanism 5, trigger mechanism 6 and electronic mechanism 7; of which the motor mechanism 2 is provided with a mandrel 20 for providing power output and also with a fixed tray 21; it is also fitted with a driving member 22. A gear mechanism 3 is engaged and driven by the driving member 22; the gear mechanism 3 is made of multiple gears 31 to form a wandering star gear pattern in cooperation with fluted disc 32, and the gear mechanism 3 is also equipped with a gear sleeve 33 for power transmission and speed change; the torsion mechanism 4 is provided with a camshaft 41 to connect coaxially with the aforementioned driving member 22; an upper clutch assembly 42 located at one end of the camshaft comprises of an annular steel bead 421, fixed steel bead plate 422, fixed steel bead cover 423, stopper 424 and bearing 425; a lower clutch assembly 43 located on other end of the camshaft 41 comprises of upper disc 431, steel bead 432, lower disc 433 and a shaft lever 44; a torsion spring 45 is sleeved onto it, and a stepped torque column 46 is covered externally, so as to set the desired torsion value; the chuck mechanism 5 includes a hollow collect with axle hole 51 and an impact lever 52 on the other end of the shaft lever 44; positioning beads 521 are set around the impact lever 52 so as to quickly incorporate each screwdriver head by means of clamping; a press spring 522 is sleeved on the impact lever 52; the trigger mechanism 6 includes a segmented control button 61 and a locking member 62 to prevent button 61 from resetting; The electronic mechanism 7 includes an electronic board 71 having function of setting different rotational speeds according to different locked objects, and a base 72 with power supply function.

Referring to FIGS. 5˜7, the present invention is characterized by that the accelerator 8 is located on the mandrel 20 of the motor mechanism 2 (namely rotor) in the said pneumatic screwdriver 1, and also combined with the motor mechanism 2; it comprises one or more metallic bearings (or sleeves) 81 with a certain weight; and the bearings (or sleeves) are sleeved on the mandrel 20 of the motor mechanism 2 for providing power output to realize deceleration.

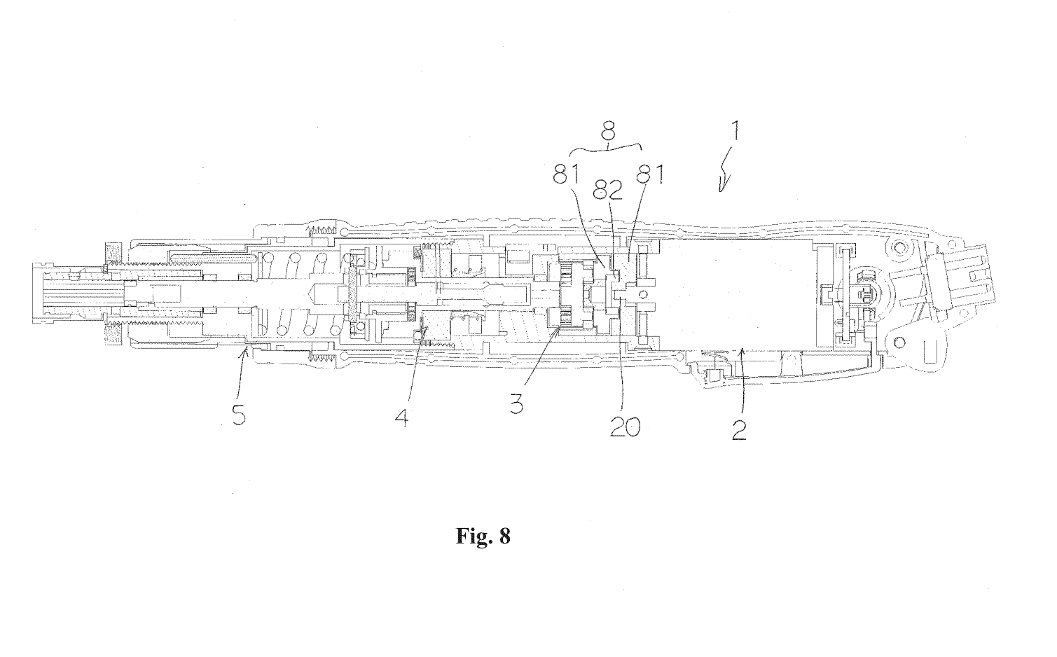

Referring to FIG. 8, when said accelerator 8 is designed with more than one bearings (or sleeves), the problems such as larger startup current and abnormal braking of the clutch could be resolved. In practice, a connecting member 82 is set onto the bearings (or sleeves) 81, so that when the motor mechanism 2 is operated, a bearing (or sleeve) 81 will firstly be driven by the mandrel 20, so as to drive another bearing (or sleeve) 81 and then the gear mechanism 3 and clutch mechanism 4, allowing for startup of the automatic screwdriver. When the locking is finished to stop the automatic screwdriver, the above-specified actions are reversed to stop the motor mechanism 2 owing to the tripping effect of clutch mechanism 4. In such case, these bearings (or sleeves) are separated, so that inertia of the accelerator 8 will be reduced and the braking of the automatic screwdriver will be restored into normal state.

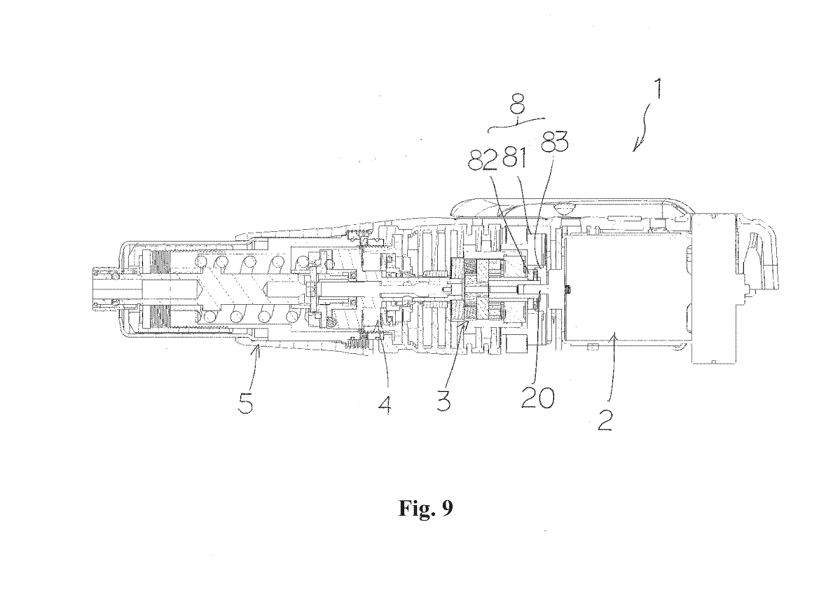

Referring to FIG. 9, as for the braking function when the motor mechanism 2 is stopped, said accelerator 8 is provided with a spring 83 located on the accelerator 8 and the mandrel 20 of the motor mechanism 2 for connecting the motor mechanism 2 with the accelerator 8; in practice, when the motor mechanism 2 is started, the remaining mechanisms are not actuated; after rotation of the mandrel 20, squeezing action of the spring 83 is driven to promote the operation of the accelerator 8 along with the gear mechanism 3 and clutch mechanism 4, allowing the automatic screwdriver to start operation. As not all mechanisms are directly operated in this starting procedure, only a small energy (small airflow or low current) output is required to supply the motor for no-load operation; and then with the functions of both the spring 83 and the accelerator 8, the horsepower and rotational speed could be gradually increased; as a result, slow start could be realized mechanically. Similarly, when the automatic screwdriver is stopped, auxiliary braking could be provided for the motor mechanism 2 via the reverse thrust of the accelerator 8 and spring 83.

Spring 83 can be replaced with a magnet and utilizing the repulsion force of magnet to drive the accelerator 8 along with the gear mechanism 3 and clutch mechanism 4, and thus, the automatic screwdriver becomes operational. This process eliminating the need to having all components to become operational, therefore, would only require a small amount of current for the motor to run.

Based on the design, when the automatic screwdriver is operated in practice, this could increase the mass and radius of the mandrel 20 (rotor) of the motor mechanism 2 for enhanced torsion; on the other hand, as the accelerator 8 is made of metal materials such as aluminum, copper, iron and steel, etc, heat dissipation could be directly realized during operation of the motor mechanism 2(cooling down by 5˜6° C. in actual test), especially for the electric screwdriver. Also, preferably there is a proper proportion between the weight selection of the accelerator 8 and the size of the motor mechanism 2, i.e. the larger motor size requires larger weight of the accelerator, vice versa. However, if the accelerator is too heavy, the overall weight of the pneumatic screwdriver 1 will be increased, making it hard for long-lasting handheld work. Conversely, if the accelerator is too light, the torsion value could not be obviously increased without functional improvement.

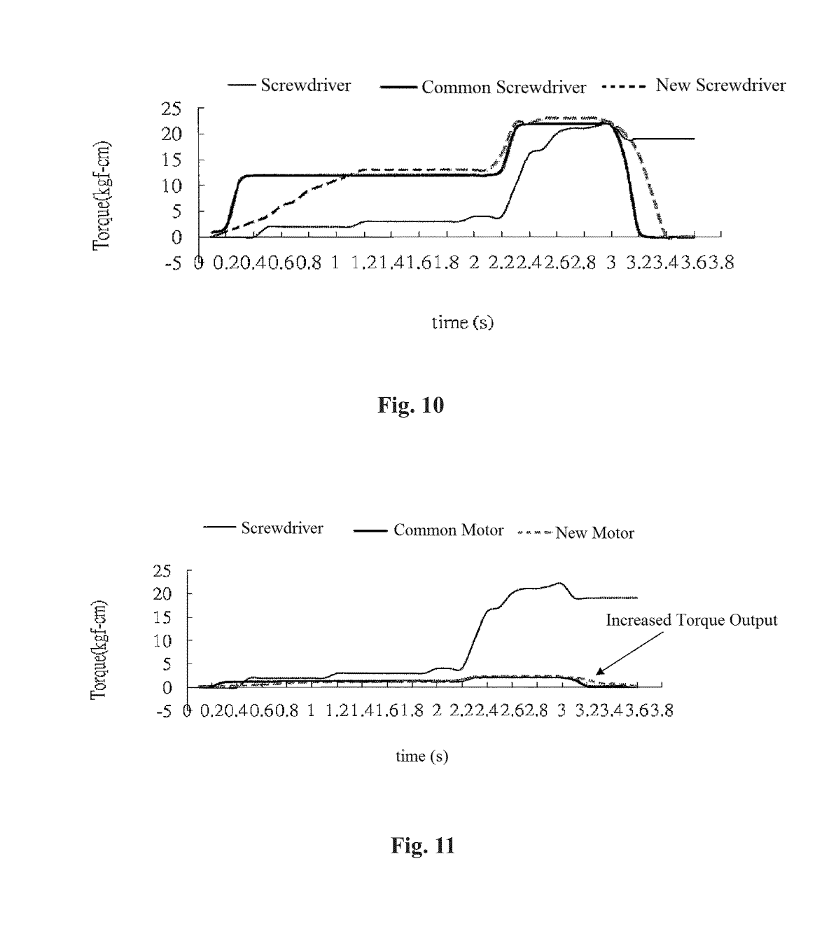

Referring to FIG. 10, as the rotational inertia of pneumatic screwdriver is increased, the response of motor turns slow, and the pneumatic screwdriver takes relatively long time from standstill to fixed no-load torsion, but the torsion is enlarged. In the case of slow rotational speed, the automatic screwdriver could be matched with a larger reduction ratio and a larger rotational inertia mechanism, thus, there is longer time for the motor to reach no-load torsion of the automatic screwdriver, so as to obtain a maximum torsion of the automatic screwdriver. In the case of fast rotational speed, the automatic screwdriver is matched with a smaller reduction ratio and a smaller rotational inertia mechanism, thus optimizing the maximum torsion.

Referring also to FIG. 11, as for the motor mechanism of the present invention, after the pneumatic screwdriver brake is stopped, the time of stopping the motor is prolonged via the reduction gear mechanism, so as to increase the torsion output of the motor mechanism and enhance the maximum torsion output of the pneumatic screwdriver.

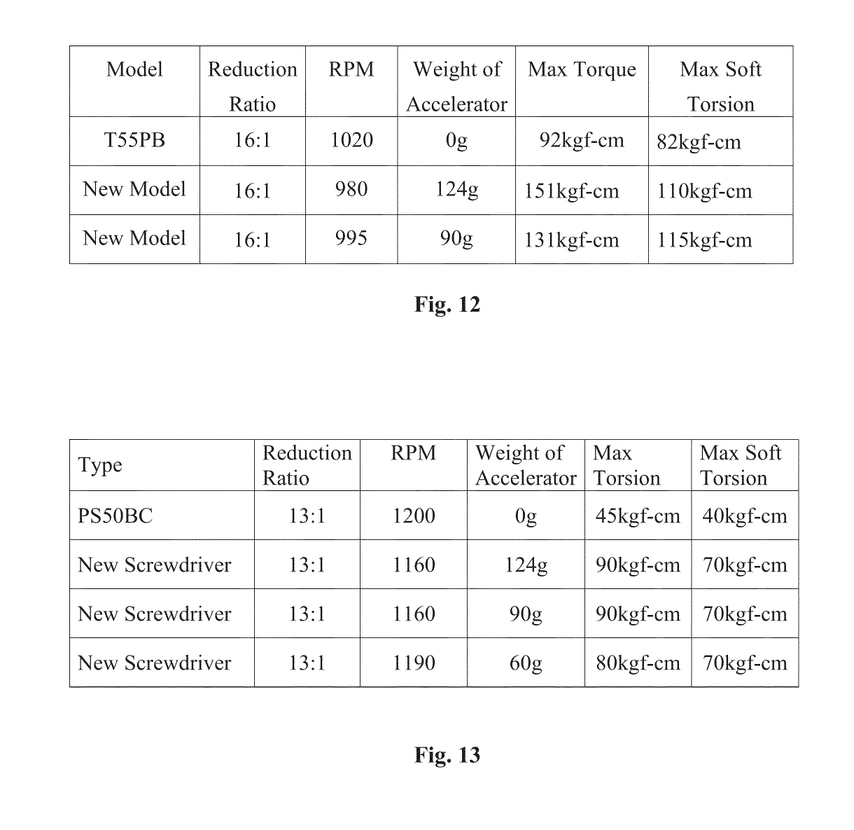

From the data in FIG. 12 that, if comparing in the same test environment using the same motor and same reduction ratio, when the accelerator is fitted to increase the rotational inertia, the pneumatic screwdriver of the present invention could increase the horsepower and torsion by 30% to 50% (depending on properties of locked screws). In this way, without change of the motor mechanism in automatic screwdriver, the torsion could be increased by the accelerator, then the locking quality could be enhanced, thus improving market competitiveness of the automatic screwdriver.

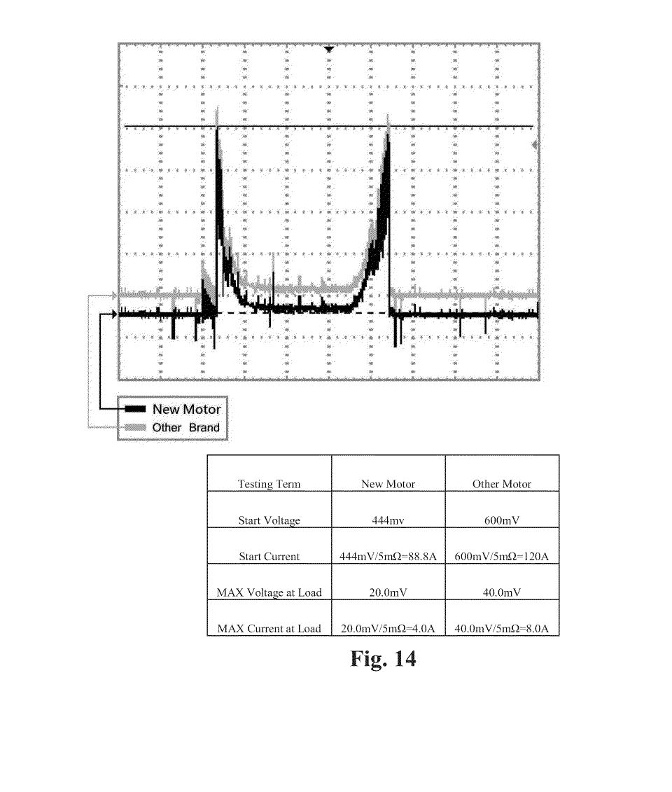

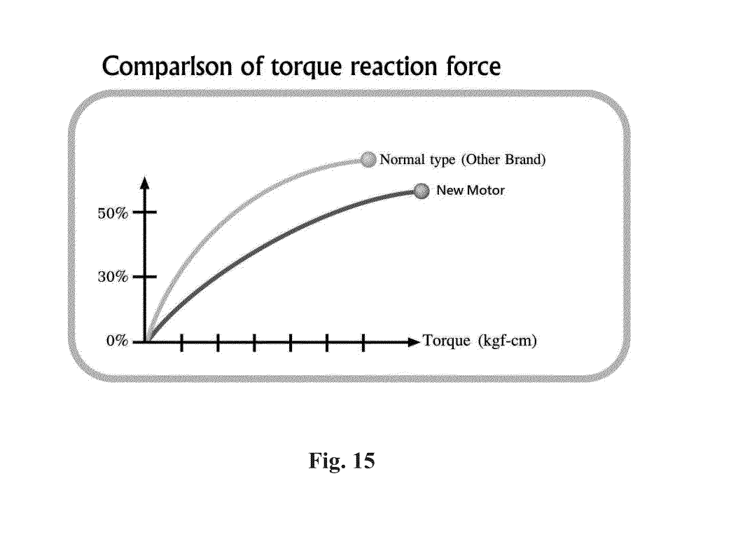

Referring also to FIGS. 14 and 15, of which FIG. 14 depicts a relational view of the motor and current when the present invention is applied to automatic screwdriver and common automatic screwdriver. When the motor mechanism is started, after rotation of the mandrel, the spring squeezing is driven to drive the operation of the accelerator and then the gear mechanism and clutch mechanism, etc, allowing the automatic screwdriver to start operation. The entire start-up process is operated progressively, so only a small current is required for the motor's no-load operation. As shown in figures, the automatic screwdriver of the present invention contains obviously lower starting voltage, current, maximum voltage load and maximum current load than common automatic screwdriver, so the start-up current of the automatic screwdriver turns smaller (similarly, the start-up airflow could also turn smaller when applied to pneumatic screwdriver), improving the horsepower and saving energy; referring to FIG. 15, based on the present invention, 30% counteraction of the torque could be reduced, so as to prevent operator's wrist from occupational injury.

In summary, as compared with prior art, the “motor accelerator for automatic screwdriver” of the present invention could significantly improve its efficacy with industrial utility value, the patent claims are made hereby in full compliance with the spirit of new patent.

Although the invention has been explained in relation to its preferred embodiment, it is to be understood that many other possible modifications and variations can be made without departing from the spirit and scope of the invention as hereinafter claimed. Although the invention has been explained in relation to its preferred embodiment, it is to be understood that many other possible modifications and variations can be made without departing from the spirit and scope of the invention as hereinafter claimed.

1. A motor accelerator for automatic screwdriver, comprising: a group of combined housings, including at least: motor mechanism, gear mechanism, torsion mechanism, chuck mechanism, trigger mechanism and electronic mechanism; it is characterized by that:
the motor mechanism is provided with an accelerator (which could be matched with the torsion and rotational speed of the automatic screwdriver) to mate with the mandrel of the motor mechanism; the accelerator comprises of a single bearing (or sleeve) or more interconnected bearings (or sleeves), so that when the motor is started up, the accelerator could be firstly driven for rotation, and then the gear and torsion mechanisms are driven, enabling smaller energy output and slow start of the automatic screwdriver.

2. The motor accelerator for automatic screwdriver as claimed in claim 1, wherein the accelerator is also provided with a spring located on the accelerator and the mandrel of the motor mechanism.

3. The motor accelerator for automatic screwdriver as claimed in claim 1, wherein the accelerator is further provided with a magnet located on the accelerator and the mandrel of the motor mechanism.

4. The motor accelerator for automatic screwdriver as claimed in claim 1, wherein the accelerator is designed with more than one bearing (or sleeve), and also provided with a connecting member for connecting the mandrel and bearing (or sleeve) of the motor mechanism.

5. The motor accelerator for automatic screwdriver as claimed in claim 1, wherein the accelerator is made of any metal material like aluminum, copper, iron and steel.

6. The motor accelerator for automatic screwdriver as claimed in claim 1, wherein the automatic screwdriver could be designed into electric or pneumatic type.

7. The motor accelerator for automatic screwdriver as claimed in claim 1, wherein the automatic screwdriver could be designed with any of vertical, gun-shaped or elbowed patterns.
